(19) United States
(12) Patent Application Publication
(10) Pub. No.: US 2026/0154794 A1
(43) Pub. Date: Jun. 4, 2026

(54) KEYFRAME EXTRACTION FROM VIDEOS

(71) Applicant: FARO Technologies, Inc., Lake Mary, FL (US)

(72) Inventors: Changyu Du, Offenbach am Main (DE); Jafar Amiri Parian, Schlieren (CH)

(21) Appl. No.: 19/412,185

(22) Filed: Dec. 8, 2025

Related U.S. Application Data
(63) Continuation of application No. PCT/US24/35692, filed on Jun. 27, 2024.
(60) Provisional application No. 63/510,744, filed on Jun. 28, 2023.

(51) Int. Cl. G06T 5/73; G06T 5/60; G06T 7/246; G06T 7/73; G06V 10/44; G06V 10/82; G06V 20/40

(52) U.S. Cl. CPC G06T 5/73; G06T 5/60; G06T 7/248; G06T 7/74; G06V 10/44; G06V 10/82; G06V 20/47; G06T 2207/10016; G06T 2207/20081; G06T 2207/20084; G06T 2207/20201; G06T 2207/30241

(57) ABSTRACT

Examples described herein provide a method that includes receiving a video of an environment. The method further includes extracting keyframes from the video using a machine learning model to generate extracted keyframes. The method further includes performing blur detection on the extracted keyframes to remove invalid keyframes from the extracted keyframes to generate candidate keyframes. The method further includes performing image enhancement on at least one of the invalid keyframes to generate at least one enhanced keyframe, the at least one enhanced keyframe being added to the candidate keyframes. The method further includes generating a desired output based at least in part on the candidate keyframes.

### CROSS-REFERENCE TO RELATED APPLICATION

This application is a continuation of PCT Application Serial No. PCT/US 24/35692, filed Jun. 27, 2024, and entitled “Keyframe Extraction From Videos,” the contents of which are incorporated by reference herein in their entirety, and this application claims the benefit of U.S. Provisional Patent Application Ser. No. 63/510,744, filed Jun. 28, 2023 and entitled “Keyframe Extraction From Videos,” the contents of which are incorporated by reference herein in their entirety.

### BACKGROUND

Processing systems (e.g., smartphones, laptop computers, tablet computers, wearable computing devices, and/or the like including combinations and/or multiples thereof) can include a sensor (e.g., a camera) for capturing images, such as of an object or environment. In some cases, the images are processed, analyzed, or otherwise used for some purpose, such as to measure environments or objects. For example, photogrammetry is a technique for measuring objects using images, such as photographic images acquired by a camera or other suitable sensor of a processing system. Photogrammetry can make 3D measurements from 2D images or photographs.

Accordingly, while existing processing systems are suitable for their intended purposes the need for improvement remains, particularly in providing a processing system have the features described herein.

### BRIEF DESCRIPTION

In one embodiment, a method is provided. The method includes receiving a video of an environment. The method further includes extracting keyframes from the video using a machine learning model to generate extracted keyframes. The method further includes performing blur detection on the extracted keyframes to remove invalid keyframes from the extracted keyframes to generate candidate keyframes. The method further includes performing image enhancement on at least one of the invalid keyframes to generate at least one enhanced keyframe, the at least one enhanced keyframe being added to the candidate keyframes. The method further includes generating a desired output based at least in part on the candidate keyframes.

In another embodiment a system includes a memory having computer readable instructions. The system further includes a processing device for executing the computer readable instructions. The computer readable instructions control the processing device to perform operations. The operation include receiving a video of an environment. The operations further include extracting keyframes from the video using a machine learning model to generate extracted keyframes. The operations further include performing blur detection on the extracted keyframes to remove invalid keyframes from the extracted keyframes to generate candidate keyframes. The operations further include performing image enhancement on at least one of the invalid keyframes to generate at least one enhanced keyframe, the at least one enhanced keyframe being added to the candidate keyframes. The operations further include generating a desired output based at least in part on the candidate keyframes.

The above features and advantages, and other features and advantages, of the disclosure are readily apparent from the following detailed description when taken in connection with the accompanying drawings.

### BRIEF DESCRIPTION OF DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 is a schematic illustration of a processing system for keyframe extraction for videogrammetry according to one or more embodiments described herein;

FIG. 2 is a schematic illustration of a system for keyframe extraction for videogrammetry according to one or more embodiments described herein;

FIG. 3A is a flow diagram of a method for keyframe extraction for videogrammetry according to one or more embodiments described herein;

FIG. 3B is a flow diagram of a method for a deep learning-based approach to extract local features and keyframes according to one or more embodiments described herein;

FIG. 4 is a flow diagram of a method for keyframe extraction for videogrammetry according to one or more embodiments described herein;

FIG. 5 is a schematic illustration of a machine learning training and inference system according to one or more embodiments described herein; and

FIG. 6 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

Embodiments described herein provide for extracting keyframes from videos from a video. According to an embodiment, keyframes are extracted from a video based on video scene changes (e.g., using machine learning). Keyframes are determined to be valid or invalid using blur detection. Image enhancement is performed on invalid extracted keyframes, such as until a certain quality threshold is satisfied, and the enhanced keyframes as well as the valid keyframes are used to generate a desired output, such as a trajectory estimation, a point cloud (e.g., a collection of 3D coordinates), a video summary, and/or the like including combinations and/or multiples thereof. One or more embodiments use photogrammetry to generate the desired output using the keyframes. For example, photogrammetry is used to perform trajectory estimation and/or generate a point cloud.

Photogrammetry is a technique for measuring objects using images, such as photographic images acquired by a digital camera for example. Photogrammetry makes 3D measurements from 2D images or photographs. When two or more images are acquired at different positions that have an overlapping field of view, common points or features are identified on each image. By projecting a ray from the camera location to the feature/point on the object, the 3D coordinate of the feature/point is determined using trigonometry or triangulation. In some examples, photogrammetry is based on markers/targets (e.g., lights or reflective stickers) or based on natural features. To perform photogrammetry, for example, images are captured, such as with a camera (e.g., the capture device 120) having a sensor, such as a photosensitive array for example. By acquiring multiple images of an object, or a portion of the object, from different positions or orientations, 3D coordinates of points on the object are determined based on common features or points and information on the position and orientation of the camera when each image was acquired. In order to obtain the desired information for determining 3D coordinates, the features are identified in two or more images. Since the images are acquired from different positions or orientations, the common features are located in overlapping areas of the field of view of the images. It should be appreciated that photogrammetry techniques are described in commonly-owned U.S. Pat. No. 10,477,180, the contents of which are incorporated by reference herein. With photogrammetry, two or more images are captured and used to generate a 3D point cloud corresponding to the images.

Videogrammetry or video-based photogrammetry applies photogrammetry techniques to video. To do this, image frames from a video are extracted and used as input for photogrammetry. While active sensors such as handheld time-of-flight (ToF) cameras and light detection and ranging (LIDAR) sensors have recently generated much attention in the industry, developments in low-cost imaging sensors have also seen improvements in recent decades.

Videogrammetry is useful as an alternative to three-dimensional (3D) scanning. For example, a device (e.g., a smartphone, a tablet computer, and/or the like, including combinations and/or multiples thereof) with an imaging sensor (e.g., a camera) is used instead of a more expensive and complex 3D scanner (e.g., a time-of-flight laser scanner). For example, such a device is used to capture a video of an environment, image frames are extracted from the video, and photogrammetry is performed on the image frames to generate a 3D point cloud corresponding to the images. A video includes sequences of images, the number of which depends on a frame rate of capture (e.g., 10 frames per second, 15 frames per second, 24 frames per second, 30 frames per second, 50 frames per second, 60 frames per second, 120 frames per second, 500 frames per second, over 1000 frames per second, and/or the like including combinations and/or multiples thereof). Although many cameras capture video at substantially 24 to substantially 50 frames per second, the techniques described herein are used for various frame rates and is not limited to any particular frame rate or range of frame rates. Performing photogrammetry using video captured by devices like smartphones is advantageous over using LIDAR sensors or similar techniques for capturing 3D information about an environment because images capture data at much higher distances compared to time-of-flight or LIDAR sensors. For example, in some embodiments a smartphone LIDAR sensor is limited to a maximum distance of substantially 5 meters.

To be effective in generating a high-quality point cloud, videogrammetry relies on high-quality input image data. Often, video data being captured are unsuitable for videogrammetry because the video data was captured too quickly/slowly, in poor lighting conditions, with improper camera settings, and/or the like, including combinations and/or multiples thereof. This causes the frames extracted from the video data to be blurry.

For videogrammetry, frames are extracted from the video, which are referred to as keyframes. According to one or more embodiments described herein, image quality of the keyframes is enhanced by improving sharpness, which reduces blurring. Filtering is then applied to provide for extracting desired keyframes are extracted. The extracted keyframes are then used to generate a point cloud, perform trajectory estimation, generate a video summary, and/or the like including combinations and/or multiples thereof.

Photogrammetry uses triangulation to determine 3D coordinates of a feature/point. By capturing images from at least two different capture locations (e.g., where the capture device is located when capturing the images), so-called “lines of sight” are developed from each capture location to features/points. These lines of sight (sometimes called “rays”) are mathematically intersected to produce the 3D coordinates of the points of interest. Compared to photos, video is easier to cover the details of al environment and is more user-friendly to capture. However, if there is triangulation/lateral movement created during capturing the images or there are motion blurs caused by quick camera movement, photogrammetry techniques are not able to process the frame (e.g., keyframe) extracted from such videos.

One shortcoming of conventional videogrammetry is how to extract high quality keyframes from redundant video data. These keyframes should be able to summarize the information of the video while maintaining a desired area of overlap between frames to provide continuity between images. One or more embodiments described herein provide techniques to sense changes in the scene and to extract contextual information adaptively.

Additionally or alternatively, one or more embodiments described herein apply image enhancement techniques, which significantly improve the results of our photogrammetry processing. For example, for video captured using an unmanned aerial vehicle (UAV), hand-held device, and/or the like, including combinations and/or multiples thereof, noise and motion blur are likely. Image enhancement techniques reduce such noise and motion blur as described herein.

Additionally or alternatively, one or more embodiments described herein adaptively adjust the processing strategy and parameters for different videos geometries (e.g., frame rectangular and spherical panorama) so that the input is optimized. For example, an iterative optimization process is described that provides acceptable quality of keyframes for photogrammetry processing.

One or more embodiments described herein provides a method for using videogrammetry for tracking, summarizing, and 3D coordinate creation. An method according to an embodiment provides for: capturing video; extracting keyframes based on video scene changes (e.g., using machine learning); detecting invalid frames in keyframes using blur detection; performing image enhancement on extracted keyframes, such as until a certain quality threshold is satisfied; and generating a desired output, such as a trajectory estimation, a point cloud (e.g., a collection of 3D coordinates), a video summary, and/or the like including combinations and/or multiples thereof.

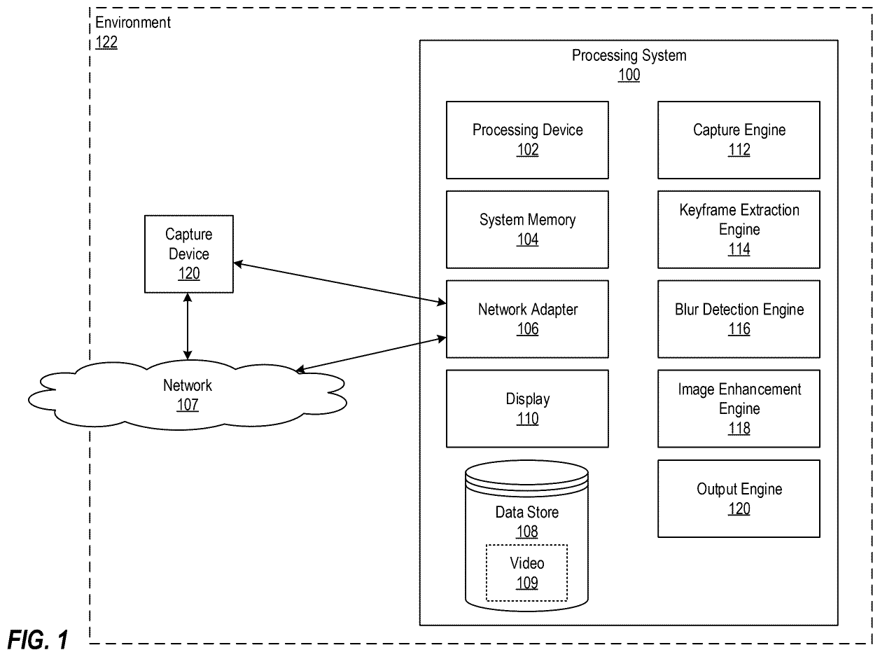

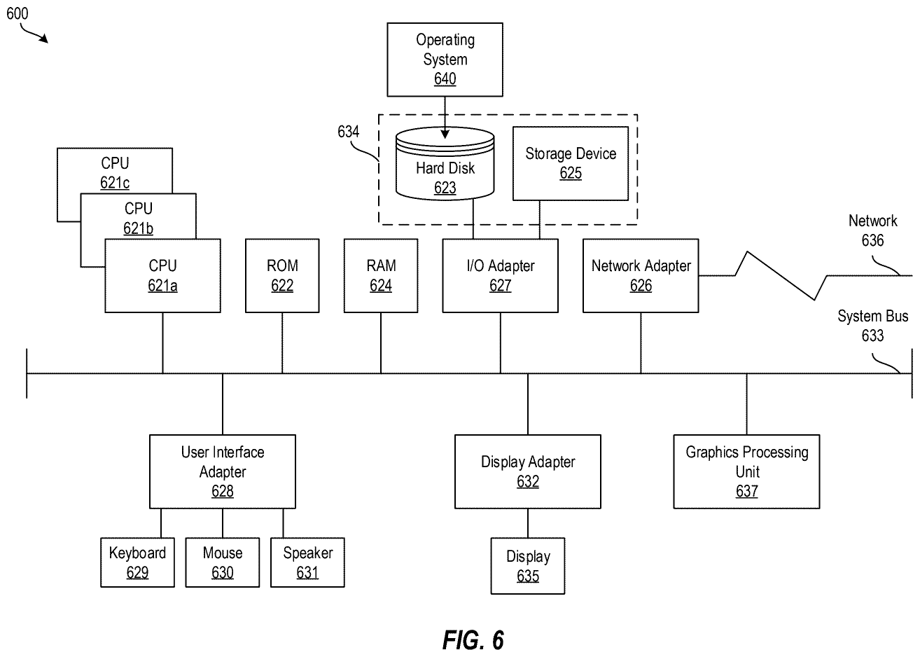

FIG. 1 is a schematic illustration of a processing system 100 for keyframe extraction for videogrammetry according to one or more embodiments described herein. The processing system 100 is any suitable computing device, such as a laptop computer, a desktop computer, a smartphone, a tablet computer, and/or the like, including combinations and/or multiples thereof. FIG. 6 depicts a processing system 600, which is an example of the processing system 100. As shown in FIG. 1, the processing system 100 includes a processing device 102 (e.g., one or more of the processing devices 621 of FIG. 6), a system memory 104 (e.g., the RAM 624 and/or the ROM 622 of FIG. 6), a network adapter 106 (e.g., the network adapter 626 of FIG. 6), a data store 108, a display 110, a capture engine 112, a keyframe extraction engine 114, a blur detection engine 116, an image enhancement engine 118, and an output engine 120.

In some embodiments, the various components, modules, engines, etc. described regarding FIG. 1 (e.g., the capture engine 112, the keyframe extraction engine 114, the blur detection engine 116, the image enhancement engine 118, and the output engine 120) are implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein is a combination of hardware and programming. In some embodiments, the programming is processor executable instructions stored on a tangible memory, and the hardware includes the processing device 102 for executing those instructions. Thus, the system memory 104 stores program instructions that when executed by the processing device 102 implement the engines described herein. In some embodiments, other engines are also utilized to include other features and functionality described in other examples herein.

The network adapter 106 enables the processing system 100 to transmit data to and/or receive data from other sources, such as a capture device 120. The capture device 120 (e.g., a smartphone having a camera, an autonomous vehicle, such as an unmanned aerial vehicle (UAV), and/or the like including combinations and/or multiples thereof) is arranged on, in, and/or around the environment 122 to capture the video 109 of the environment 122. The capture device 120 is any suitable device for capturing video, such as a digital camera, smartphone having a camera, a panoramic camera, a 360-degree omnidirectional camera, and/or the like, including combinations and/or multiples thereof. The capture device 120 includes one or more imaging sensors for capturing the video about the environment 122. According to one or more embodiments described herein, the capture device 120 includes a charge-coupled device (CCD), a complementary metal-oxide semiconductor (CMOS) image sensor, and/or the like including combinations and/or multiples thereof. The processing system 100 receives data (e.g., video) from the capture device 120 directly and/or via a network 107. The data from the capture device 120 is stored in the data store 108 of the processing system 100 as video 109, which is displayed on the display 110. According to one or more embodiments described herein, the capture engine 112 is used to control the capture device 120, to cause the capture device 120 to capture the video 109, to request the video 109 from the capture device 120, to cause the processing system 100 to receive the video 109 from the capture device 120 and/or the like including combinations and/or multiples thereof.

The network 107 represents any one or a combination of different types of suitable communications networks such as, for example, cable networks, public networks (e.g., the Internet), private networks, wireless networks, cellular networks, or any other suitable private and/or public networks. Further, the network 107 has any suitable communication range associated therewith and include, for example, global networks (e.g., the Internet), metropolitan area networks (MANs), wide area networks (WANs), local area networks (LANs), or personal area networks (PANs). In addition, the network 107 includes any type of medium over which network traffic is carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

Using the data (e.g., the video 109) received from the capture device 120, the processing system 100 extracts keyframes from the video 109 using the keyframe extraction engine 114, detects blur in the keyframes using the blur detection engine 116, removes blur from the keyframes using the image enhancement engine 118, and generates an output (e.g., a point cloud, a trajectory, a video summary, and/or the like including combinations and/or multiples thereof) using the output engine 120. The features and functionality of the capture engine 112, the keyframe extraction engine 114, the blur detection engine 116, the image enhancement engine 118, and the output engine 120 are now described in more detail with reference to the following figures.

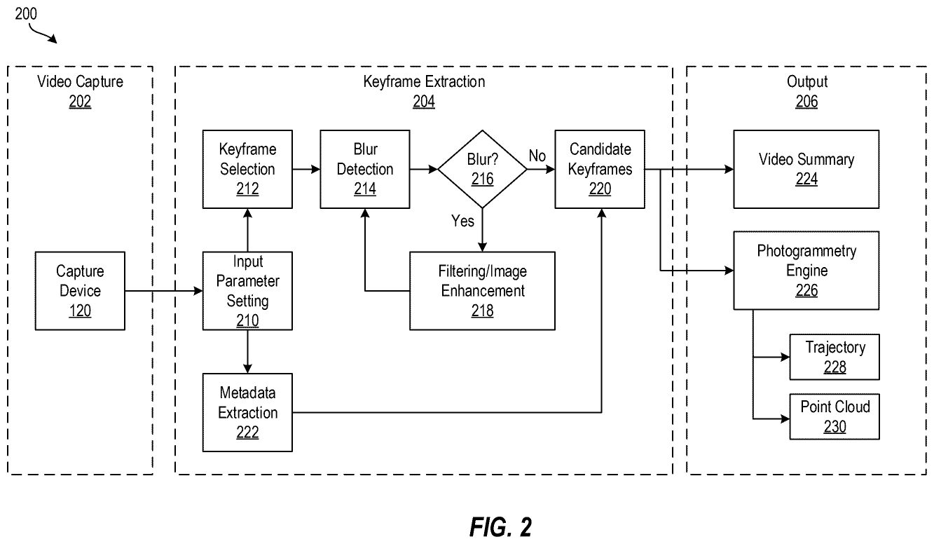

FIG. 2 is a schematic illustration of a system 200 for keyframe extraction for videogrammetry according to one or more embodiments described herein. The system 200 includes video capture 202, keyframe extraction 204, and output 206.

During the video capture 202, the capture device 120 captures a video of an environment. For example, the capture device 120 captures the video 109 of the environment 122. The capture device 120 then sends the video 109 to the processing system 100 directly and/or indirectly (e.g., via the network 107, via a remote processing system, via a cloud computing system, and/or the like including combinations and/or multiples thereof.)

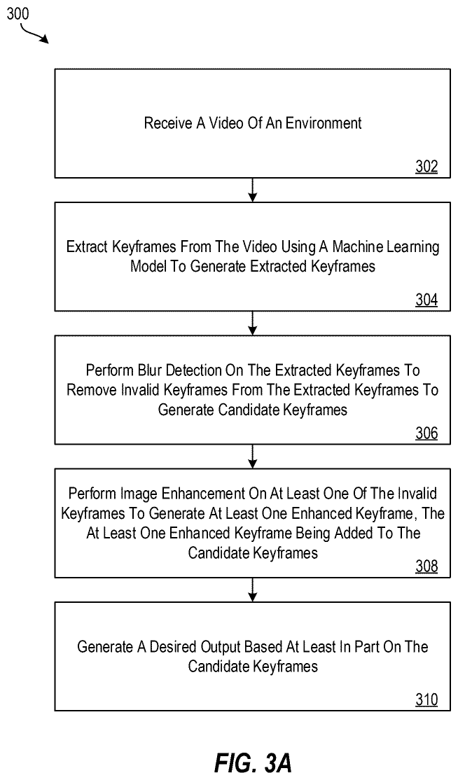

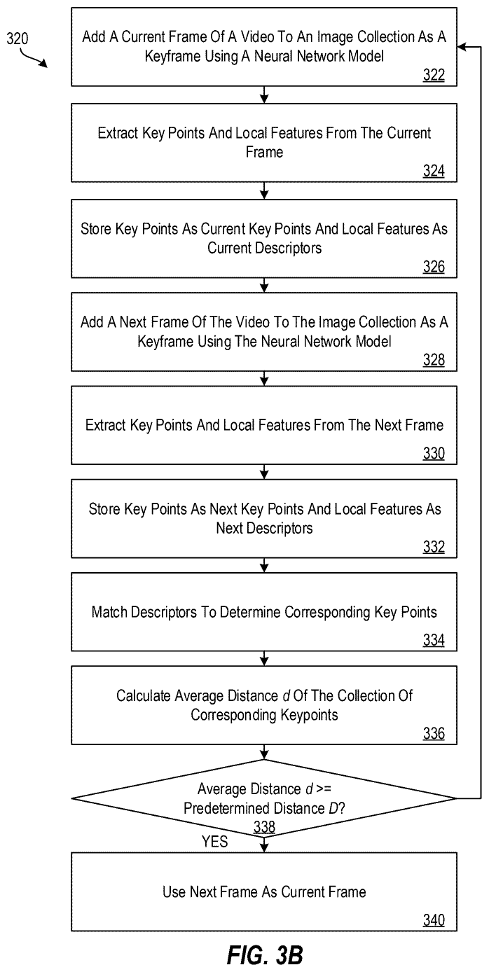

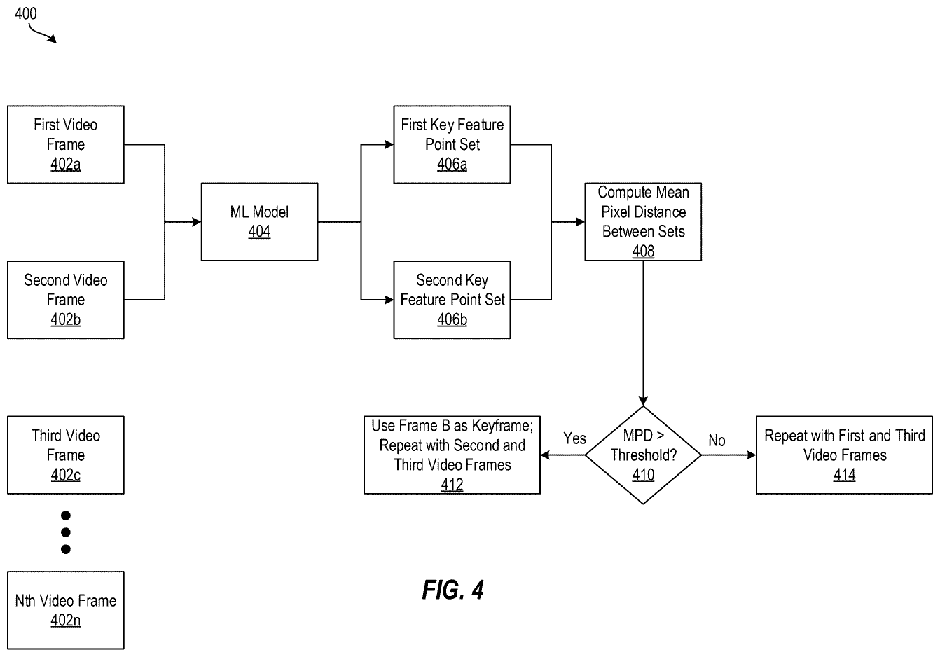

During the keyframe extraction 204, the processing system 100 extracts keyframes from the video to generate candidate keyframes 220 using the keyframe extraction engine 114. The keyframe extraction engine 114 sets input parameters (block 210). Non-limiting examples of the input parameters include frame rate, quality (e.g., resolution of the image), denoising, and/or the like including combinations and/or multiples thereof. At block 212, the keyframe extraction engine 114 selects keyframes from the video 109. According to one or more embodiments described herein, the keyframe extraction engine 114 uses a deep learning-based approach to extract local features and keyframes (see, e.g., FIG. 3B and FIG. 4). At block 214, the blur detection engine 116 determines whether a keyframe extracted at block 212 includes blur. For example, the blur detection engine 116 determines how much blur is present in a keyframe and compares it to a threshold to determine, at block 216, whether blur is present, where blur is determined to be present when the amount of blur is greater than a threshold. In some cases, the threshold is zero such that any blur is detected; however, in other cases, the threshold is greater than zero such that some amount of blur is acceptable while amounts of blur greater than the threshold is unacceptable. Where no blur is detected at block 216, or where the amount of blur is less than the threshold, the keyframe is added to the candidate keyframes.

According to one or more embodiments described herein, the blur detection engine 214 performs blur detection at block 214 as follows. For example, one approach to determining an amount of blur (e.g., to calculate a blur value for a keyframe) is to convolve the image with a Laplacian kernel and then calculate the variance on the convolution result. If the variance falls below a pre-defined threshold, then the keyframe is considered blurry at block 216; otherwise, the image is not blurry at block 216. The Laplacian operator highlights regions of the keyframe that contain rapid intensity changes, which is often used for edge detection. A keyframe with a high variance (e.g., greater than a threshold) indicates that there is a wide range of responses, including both edge-like and non-edge-like, which is representative of a normally focused keyframe. But if the variance is low (e.g., less than the threshold), then there is a smaller spread range of response, which indicates that there are almost no edges in the keyframe. The more blurred the keyframe is, the less edges are present.

According to one or more embodiments described herein, the blur detection engine 214 performs blur detection at block 214 using a blur detect filter, such as the blurdetect filter from FFmpeg. FFmpeg is a multimedia framework capable of decoding, encoding, transcoding, muxing, demuxing, streaming, filtering, and playing many different formats of video. The blurdetect filter from FFmpeg is used to compute a blur value for each keyframe, as described in “A no-reference perceptual blur metric” to Marziliano, Pina et al., which provides a no-reference blur metric for images and video. This approach is performed as follows according to one or more embodiments described herein. First, an edge detector is applied (e.g., a vertical Sobel filter) in order to identify vertical edges in the keyframes. Then each row of the keyframe is scanned. For pixels corresponding to an edge location, the start and end positions of the edge are defined as the local extrema locations closest to the edge. The edge width is then given by the difference between the end and start positions and is identified as the local blur measure for this edge location. Finally, a global blur measure for the keyframe is obtained by averaging the local blur values over the edge locations.

Where blur is detected at block 216, or where the amount of blur exceeds the threshold, filtering/image enhancement is performed on the keyframe at block 218., an example of which is the MAXIM model as described in “MAXIM: Multi-Axis MLP for Image Processing” by Tu, Zhengzhong, et al. The MAXIM model is useful for performing image enhancement tasks such as denoising (e.g., removing noise), deblurring (e.g., removing blur), deraining (e.g., removing rain), dehazing (e.g., removing haze), and/or the like including combinations and/or multiples thereof. Other techniques for image enhancement are used, additionally or alternatively, by the image enhancement engine 118 to enhance keyframes at block 218.

After the input parameters are set at block 210, the keyframe extraction engine 114 also extracts metadata at block 222. The metadata includes, but is not limited to, parameters associated with the camera (e.g., capture device 120), a type of the capture device 120, GPS coordinates, and/or the like including combinations and/or multiples thereof. According to one or more embodiments described herein, the metadata extraction at block 222 is performed using any suitable tool for metadata extraction from images, such as the ExifTool. The metadata is passed to and/or stored with the candidate keyframes 220. According to one or more embodiments described herein, the metadata is used to align keyframes. For example, the metadata and/or additional metadata is used to provide more reliable trajectory reconstruction. Non-limiting examples of additional metadata includes GPS coordinates, acceleration, height variation, direction of movement, gravity axis, and/or the like including combinations and/or multiples thereof.

The output 206 uses the candidate keyframes in various ways. For example, the output engine 120 of the processing system 100 generates a video summary of the video at block 224, generates a trajectory for the capture device 120 at block 228, generates a point cloud at block 230, and/or the like including combinations and/or multiples thereof. For example, the output engine 120 uses a photogrammetry engine 226 to generate the trajectory at block 228 and/or to generate the point cloud at block 230. For example, a photogrammetry technique is applied to candidate keyframes 220 to generate the trajectory and/or point cloud. Photogrammetry is a technique for measuring objects using images, such as photographic images acquired by a digital camera for example. Photogrammetry makes 3D measurements from 2D images or photographs. When two or more images are acquired at different positions that have an overlapping field of view, common points or features are identified on each image. By projecting a ray from the camera location (e.g., of the capture device 120) to the feature/point on the object, the 3D coordinate of the feature/point is determined using trigonometry or triangulation. In some examples, photogrammetry is based on markers/targets (e.g., lights or reflective stickers) or based on natural features. To perform photogrammetry, for example, images are captured, such as with a camera having a sensor, such as a photosensitive array for example. By acquiring multiple images of an object, or a portion of the object, from different positions or orientations, 3D coordinates of points on the object are determined based on common features or points and information on the position and orientation of the camera when each image was acquired. In order to obtain the desired information for determining 3D coordinates, the features are identified in two or more images. Since the images are acquired from different positions or orientations, the common features are located in overlapping areas of the field of view of the images. It should be appreciated that photogrammetry techniques are described in commonly-owned U.S. Pat. No. 10,597,753, the contents of which are incorporated by reference herein. With photogrammetry, two or more images are captured and used to determine 3D coordinates of features, which are then used to generate the trajectory at block 228 and/or to generate a point cloud at block 230.

FIG. 3A is a flow diagram of a method for keyframe extraction for videogrammetry according to one or more embodiments described herein. The method 200 is performed by any suitable system or device, such as the processing system 100 of FIG. 1 and/or the processing system 600 of FIG. 6. FIG. 3A is now described in more detail with reference to FIGS. 1, 2, and 4-6 but is not so limited.

At block 302, the processing system 100 receives video (e.g., the video 109) of an environment. The video 109 is captured by the capture device 120 and is stored in the data store 108 of the processing system 100 and/or another suitable data store, such as a node of a cloud computing system (not shown). According to one or more embodiments described herein, the processing system 100 uses the capture engine 112 to control the capture device 120, to cause the capture device 120 to capture the video 109, to request the video 109 from the capture device 120, to cause the processing system 100 to receive the video 109 from the capture device 120 and/or the like including combinations and/or multiples thereof.

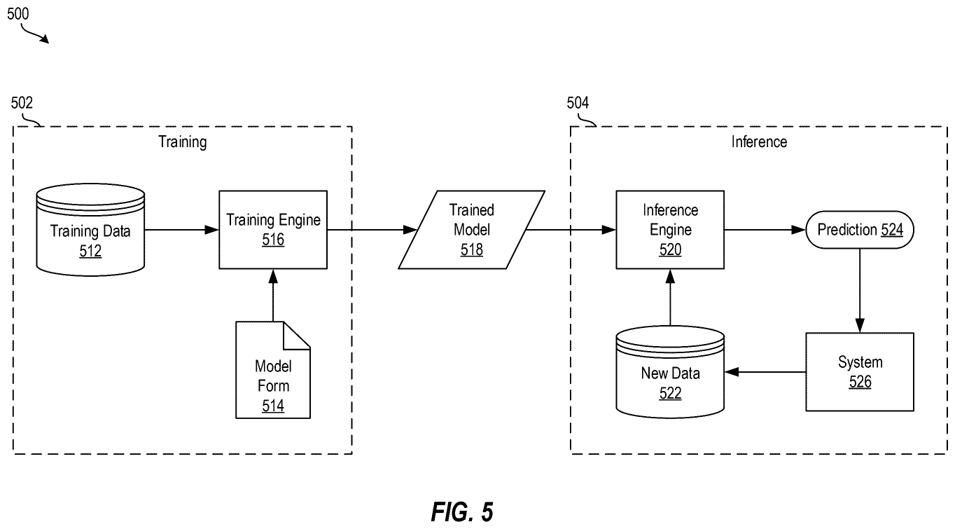

At block 304, the processing system 100, using the keyframe extraction engine 114, extracts keyframes from the video using a machine learning model to generate extracted keyframes. According to one or more embodiments described herein, the keyframe extraction engine 114 implements a deep learning-based approach to extract local features and keyframes based on the magnitude of change in a scene view of the video 109. According to one or more embodiments described herein, the keyframe extraction engine 114 utilizes machine learning as described with reference to the a machine learning training and inference system 500 of FIG. 5.

The deep learning-based approach to extract local features and keyframes is now described with reference to the method 320 of FIG. 3B according to one or more embodiments described herein. An example of such a deep-learning based approach is as follows. At block 322, a current frame of the video 109 is added to an image collection as a keyframe using a neural network model (e.g., “SuperPoint: Self-Supervised Interest Point Detection and Description” by Daniel DeTone et al.). At block 324, key points and local features are extracted from the current frame, where keypoints are a collection of pixel coordinates, and local features are features corresponding to pixel points). At block 326, the key points are stored as current key points (“cur_keypoints”) and local features are stored as current descriptors (“cur_descriptors”). At blocks 328, 330, and 332, for a next frame of the video 109, a similar approach is used to extract key points and local features as the previous frame. Namely, at block 328, a next frame of the video is added to the image collection as a keyframe using the neural network model. At block 330, keypoints and local features for the next frame are extracted. At block 332, the key points are stored as next key points (“next_keypoints”) and the local features are stored as next descriptors (“next_descriptors”). Then, at block 334, the next descriptors (e.g., “next_descriptors”) are matched with the descriptors from the previous frame (e.g., “cur_descriptors”) to determine corresponding key points of the key points from the previous frame (e.g., “cur_keypoints”) in the next keypoints (e.g., “next_keypoints”). A distance is then calculated between corresponding keypoints, and at block 336, the average distance d is calculated of the collection of corresponding keypoints. If the average distance d is greater than or equal to a predetermined threshold distance D at decision block 338, the next frame is used as the current frame (block 340), and the keyframe extraction engine 114 repeats the deep learning-based approach to extract local features and keyframes. If the average distance d is less than the predetermined threshold distance D at decision block 338, the method 320 is repeated with subsequent frames until the video 109 is completed, at which point the method 320 terminates. This approach to keyframe extraction provides for light weight preprocessing to filter out usable information from the captured images without undertaking the more processing resource intensive approach used by conventional photogrammetry algorithms. The method 320 now is further described with reference to FIG. 4.

For example, FIG. 4 is a flow diagram of a method 400 for keyframe extraction for videogrammetry according to one or more embodiments described herein. The method 300 is performed by any suitable system or device, such as the processing system 100 of FIG. 1 and/or the processing system 600 of FIG. 6. The method 300 receives a first video frame 402a and a second video frame 402b, a block 404, a machine learning model 404 is used to extract keyframes. Particularly, the ML model 404 extracts a first key feature point set 406a corresponding to the first video frame 402a and extracts a second key feature point set 406b corresponding to the second video frame 402b. The method 400 computes a mean pixel distance between the sets 406a, 406b at block 408 and determines, at block 410, whether the mean pixel distance (MPD) is greater than a threshold. If so (“YES” at block 410), the method 400 proceeds to block 412 where the second video frame 402b is used as the keyframe, and the method 400 is repeated with the second video frame 402b and a third video frame 402c. If not (“NO” at block 410), the method 400 repeats with the first video frame 402a and the third video frame 402c. The method 400 is repeated for each of the video frames from the first video frame 402a to an Nth video frame 402n. The method 400 provides an image content-based approach that provides for high scene overlap without frame redundancy, is suitable for different kinds of video (e.g., fisheye videos, 360 degree videos, and/or the like including combinations and/or multiples thereof), is robust and stable compared to conventional approaches, is executable on a central processing unit and/or a graphics processing unit, among others.

With continued reference to FIG. 3A, at block 306, the blur detection engine 116 of the processing system 100 performs blur detection on the extracted keyframes from block 204 to remove invalid keyframes from the extracted keyframes to generate candidate keyframes. That is, blur detection is performed on the extracted keyframes to determine which, if any, of the extracted keyframes are blurry. If keyframes are determined to be blurry, or to include a threshold amount of blurriness, such keyframes are determined to be invalid. Extracted keyframes that are not determined to be blurry or that are not determined to include a threshold amount of blurriness are included in candidate keyframes. Blur detection is performed as described herein, for example, with reference to FIG. 2. For example, blur detection is performed by convolving the image with a Laplacian kernel and calculating the variance on the convolution result. As another example, blur detection is performed using a blur detect filter. Other approaches to blur detection are implemented in other embodiments.

At block 308, the image enhancement engine 118 of the processing system 100 performs image enhancement on at least one of the invalid keyframes to generate at least one enhanced keyframe, the at least one enhanced keyframe being added to the candidate keyframes from block 206. For example, the image enhancement engine 118 enhances keyframes that are determined to be blurred or to have an undesirable amount of blur at block 216. According to one or more embodiments described herein, the image enhancement engine 118 applies a machine learning-based deblurring technique.

According to one or more embodiments described herein, not all keyframes that are identified as blurry are removed via filtering. For example, blurred keyframes appear in succession, and therefore removing them all would cause the scene to jump/skip. In an effort to address this, one or more embodiments apply a filtering approach as follows. The blur detection engine 116 outputs an array (e.g., [0,0,0,1,1,1,1,1,0,1,0]), where each item in the array indicates a keyframe in a video sequence with “0 ” indicating not blurred (e.g., below a threshold amount of blur) and “1” indicating blurred (e.g., exceeding a threshold amount of blur). First, the blur keyframes are grouped (e.g., [0,0,0,(1,1,1,1,1),0,(1),0]). Next, a user sets an interval parameter to determine, from how many consecutive blurred frames are to be kept. Suppose the user selects an interval equal to “2,” then the array changes based on the user selected interval (e.g., [0,0,0,((1,1),(1,1),(1)),0,((1)),0]). The less blurred frame(s) from this interval are kept and sent to the image enhancement engine 118 (e.g., [0,0,0,((1,1),(1,1),(1)),0,((1)),0], where the bold frames are kept). This approach avoids scene jumping/skipping, reduces the data amount processed by the image enhancement engine 118, and provides for user-customized intervals according to the user's own data.

At block 310, the output engine 120 of the processing system 100 generates a desired output based at least in part on the candidate keyframes from blocks 306 and 308. One example of a desired output is a video summary of the video 109. A video summary is a collection of keyframes from the video 109. Another example of a desired output is a trajectory for the capture device 120. Yet another example of a desired output is a point cloud, which is generated from the keyframes using photogrammetry techniques, for example.

In some embodiments, additional processes are also included, and it should be understood that the process depicted in FIG. 3 represents an illustration, and that other processes are added or existing processes are removed, modified, or rearranged without departing from the scope of the present disclosure.

One or more embodiments described herein utilize machine learning techniques to perform tasks, such as keyframe extraction, motion deblurring, and/or the like including combinations and/or multiples thereof. More specifically, one or more embodiments described herein incorporate and utilize rule-based decision making and artificial intelligence (AI) reasoning to accomplish the various operations described herein, namely keyframe extraction and motion deblurring. The phrase “machine learning” broadly describes a function of electronic systems that learn from data. A machine learning system, engine, or module includes a trainable machine learning algorithm that is trained, such as in an external cloud environment, to learn functional relationships between inputs and outputs, and the resulting model (sometimes referred to as a “trained neural network,” “trained model,” and/or “trained machine learning model”) is used for keyframe extraction, for example. Multiple models are trained, for example, such that a first model is trained to perform keyframe extraction and a second model is trained to perform motion deblurring. In one or more embodiments, machine learning functionality is implemented using an artificial neural network (ANN) having the capability to be trained to perform a function. In machine learning and cognitive science, ANNs are a family of statistical learning models inspired by the biological neural networks of animals, and in particular the brain. ANNs are used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and are used in accordance with one or more embodiments described herein.

ANNs are embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights are adjusted and tuned based on experience, making ANNs adaptive to inputs and capable of learning. For example, an ANN for handwriting recognition is defined by a set of input neurons that are activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques are applied in the case of keyframe extraction and/or motion deblurring as described herein.

Systems for training and using a machine learning model are now described in more detail with reference to FIG. 5. Particularly, FIG. 5 depicts a block diagram of components of a machine learning training and inference system 500 according to one or more embodiments described herein. The system 500 performs training 502 and inference 504. During training 502, a training engine 516 trains one or more models (e.g., the trained model 518) to perform a task or tasks, such as to extract keyframes, to detect motion blur, to deblur an image, and/or the like including combinations and/or multiples thereof. Inference 504 is the process of implementing the trained model 518 to perform the task, in the context of a larger system (e.g., a system 526). In some embodiments, all or a portion of the system 500 shown in FIG. 5 is implemented, for example by all or a subset of the processing system 100 of FIG. 1.

The training 502 begins with training data 512, which is structured or unstructured data. According to one or more embodiments described herein, for a model for extracting keyframes, the training data 512 includes standard images together with homography-patchy images. Standard images are the captured images in their original form. Homography-patchy images are images having patches extracted from image sequence. For each sequence, patches are detected and projected on target images using a ground-truth homography as described in “HPatches: A benchmark and evaluation of handcrafted and learned local descriptors” to Balntas et al. Other suitable types of training data are also used. For a model for deblurring an image, the training data 512 includes pairs of images with a blurred image and a non-blurred image. The training engine 516 receives the training data 512 and a model form 514. The model form 514 represents a base model that is untrained. The model form 514 has preset weights and biases, which are adjusted during training. It should be appreciated that the model form 514 is selected from many different model forms depending on the task to be performed. For example, where the training 502 is to train a model to perform image classification, the model form 514 is a model form of a CNN. The training 502 is supervised learning, semi-supervised learning, self-supervised learning, unsupervised learning, reinforcement learning, and/or the like, including combinations and/or multiples thereof. For example, supervised learning is used to train a machine learning model to classify an object of interest in an image. To do this, the training data 512 includes labeled images, including images of the object of interest with associated labels (ground truth) and other images that do not include the object of interest with associated labels. In this example, the training engine 516 takes as input a training image from the training data 512, makes a prediction for classifying the image, and compares the prediction to the known label. The training engine 516 then adjusts weights and/or biases of the model based on results of the comparison, such as by using backpropagation. The training 502 is performed multiple times (referred to as “epochs”) until a suitable model is trained (e.g., the trained model 518).

Once trained, the trained model 518 is used to perform inference 504 to perform a task, such as to extract keyframes, to deblur an image, and/or the like including combinations and/or multiples thereof. The inference engine 520 applies the trained model 518 to new data 522 (e.g., real-world, non-training data). For example, if the trained model 518 is trained to classify images of a particular object, such as a chair, the new data 522 is an image of a chair that was not part of the training data 512. In this way, the new data 522 represents data to which the model 518 has not been exposed. The inference engine 520 makes a prediction 524 (e.g., a classification of an object in an image of the new data 522) and passes the prediction 524 to the system 526 (e.g., the processing system 100 of FIG. 1). The system 526, based on the prediction 524, takes an action, performs an operation, performs an analysis, and/or the like, including combinations and/or multiples thereof. In some embodiments, the system 526 adds to and/or modifies the new data 522 based on the prediction 524.

In accordance with one or more embodiments, the predictions 524 generated by the inference engine 520 are periodically monitored and verified to ensure that the inference engine 520 is operating as expected. Based on the verification, additional training 502 occurs using the trained model 518 as the starting point. The additional training 502 includes all or a subset of the original training data 512 and/or new training data 512. In accordance with one or more embodiments, the training 502 includes updating the trained model 518 to account for changes in expected input data.

It is understood that one or more embodiments described herein is capable of being implemented in conjunction with any other type of computing environment now known or later developed. For example, FIG. 6 depicts a block diagram of a processing system 600 for implementing the techniques described herein. In accordance with one or more embodiments described herein, the processing system 600 is an example of a cloud computing node of a cloud computing environment. In examples, processing system 600 has one or more central processing units (“processors” or “processing resources” or “processing devices”)621a, 621b, 621c, etc. (collectively or generically referred to as processor(s) 621 and/or as processing device(s)). In aspects of the present disclosure, each processor 621 includes a reduced instruction set computer (RISC) microprocessor. Processors 621 are coupled to system memory (e.g., random access memory (RAM) 624) and various other components via a system bus 633. Read only memory (ROM) 622 is coupled to system bus 633 and includes a basic input/output system (BIOS), which controls certain basic functions of processing system 600.

Further depicted are an input/output (I/O) adapter 627 and a network adapter 626 coupled to system bus 633. I/O adapter 627 is a small computer system interface (SCSI) adapter that communicates with a hard disk 623 and/or a storage device 625 or any other similar component. I/O adapter 627, hard disk 623, and storage device 625 are collectively referred to herein as mass storage 634. Operating system 640 for execution on processing system 600 is stored in mass storage 634. The network adapter 626 interconnects system bus 633 with an outside network 636 enabling processing system 600 to communicate with other such systems.

A display (e.g., a display monitor) 635 is connected to system bus 633 by display adapter 632, which includes a graphics adapter to improve the performance of graphics intensive applications and a video controller. In one aspect of the present disclosure, adapters 626, 627, and/or 632 are connected to one or more I/O busses that are connected to system bus 633 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 633 via user interface adapter 628 and display adapter 632. A keyboard 629, mouse 630, and speaker 631 are interconnected to system bus 633 via user interface adapter 628, which includes, for example, a Super I/O chip integrating multiple device adapters into a single integrated circuit.

In some aspects of the present disclosure, processing system 600 includes a graphics processing unit 637. Graphics processing unit 637 is a specialized electronic circuit designed to manipulate and alter memory to accelerate the creation of images in a frame buffer intended for output to a display. In general, graphics processing unit 637 is very efficient at manipulating computer graphics and image processing, and has a highly parallel structure that makes it more effective than general-purpose CPUs for algorithms where processing of large blocks of data is done in parallel.

Thus, as configured herein, processing system 600 includes processing capability in the form of processors 621, storage capability including system memory (e.g., RAM 624), and mass storage 634, input means such as keyboard 626 and mouse 630, and output capability including speaker 631 and display 635. In some aspects of the present disclosure, a portion of system memory (e.g., RAM 624) and mass storage 634 collectively store the operating system 640 to coordinate the functions of the various components shown in processing system 600.

In addition to one or more of the features described herein, or as an alternative, further embodiments of the method includes that generating the desired output includes generating a video summary of the video using the candidate keyframes.

In addition to one or more of the features described herein, or as an alternative, further embodiments of the method includes that generating the desired output includes estimating a trajectory for the video using the candidate keyframes.

In addition to one or more of the features described herein, or as an alternative, further embodiments of the method includes that generating the desired output includes generating a point cloud of the environment using the candidate keyframes.

In addition to one or more of the features described herein, or as an alternative, further embodiments of the method includes that the video of the environment is captured by a capture device.

In addition to one or more of the features described herein, or as an alternative, further embodiments of the method includes that extracting the keyframes is performed using a deep learning-based approach to extract local features and keyframes.

In addition to one or more of the features described herein, or as an alternative, further embodiments of the method includes that the deep learning-based approach includes: for a first keyframe of the video: add the first keyframe of the video to an image collection using a neural network model; extracting first key points and first local features from the first keyframe of the video; and storing the first key points as current key points and the first local features as current descriptors; and for a second keyframe of the video: adding the second keyframe of the video to the image collection using the neural network model; extracting second key points and second local features from the second keyframe of the video; and storing the second key points as next key points and the second local features as next descriptors.

In addition to one or more of the features described herein, or as an alternative, further embodiments of the method includes that the deep learning-based approach further includes: matching the current descriptors and the next descriptors to determine corresponding key points between the current key points and next key points; and calculating an average distance of the corresponding key points; determining whether the average distance.

In addition to one or more of the features described herein, or as an alternative, further embodiments of the method includes that the deep learning-based approach further includes: responsive to determining that the average distance of the corresponding key points exceeds the threshold distance, use the second keyframe as the current frame and repeat the deep learning-based approach to extract local features and keyframes.

In addition to one or more of the features described herein, or as an alternative, further embodiments of the method includes that the deep learning-based approach further includes: responsive to determining that the average distance of the corresponding key points does not exceed the threshold distance, repeating the keyframe extraction using subsequent keyframes until the video is complete.

In addition to one or more of the features described herein, or as an alternative, further embodiments of the method includes that performing the blur detection includes convolving the extracted keyframes with a Laplacian kernel, calculating a variance on the convolution result, and using the variance to determine whether one or more of the extracted keyframes are valid or invalid.

In addition to one or more of the features described herein, or as an alternative, further embodiments of the method includes that performing the blur detection includes applying a blur detect filter.

In addition to one or more of the features described herein, or as an alternative, further embodiments of the method includes that performing the image enhancement on the at least one of the invalid keyframes to generate the at least one enhanced keyframe includes applying a machine learning-based deblurring technique.

In addition to one or more of the features described herein, or as an alternative, further embodiments of the processing system includes that generating the desired output includes generating a video summary of the video using the candidate keyframes.

In addition to one or more of the features described herein, or as an alternative, further embodiments of the processing system includes that generating the desired output includes estimating a trajectory for the video using the candidate keyframes.

In addition to one or more of the features described herein, or as an alternative, further embodiments of the processing system includes that generating the desired output includes generating a point cloud of the environment using the candidate keyframes.

In addition to one or more of the features described herein, or as an alternative, further embodiments of the processing system includes that the video of the environment is captured by a capture device.

In addition to one or more of the features described herein, or as an alternative, further embodiments of the processing system includes that extracting the keyframes is performed using a deep learning-based approach to extract local features and keyframes.

In addition to one or more of the features described herein, or as an alternative, further embodiments of the processing system includes that the deep learning-based approach includes: for a first keyframe of the video: add the first keyframe of the video to an image collection using a neural network model; extracting first key points and first local features from the first keyframe of the video; storing the first key points as current key points and the first local features as current descriptors; and for a second keyframe of the video: adding the second keyframe of the video to the image collection using the neural network model; extracting second key points and second local features from the second keyframe of the video; storing the second key points as next key points and the second local features as next descriptors.

In addition to one or more of the features described herein, or as an alternative, further embodiments of the processing system includes that the deep learning-based approach further includes: matching the current descriptors and the next descriptors to determine corresponding key points between the current key points and next key points; calculating an average distance of the corresponding key points; and determining whether the average distance.

In addition to one or more of the features described herein, or as an alternative, further embodiments of the processing system includes that the deep learning-based approach further includes: responsive to determining that the average distance of the corresponding key points exceeds the threshold distance, use the second keyframe as the current frame and repeat the deep learning-based approach to extract local features and keyframes.

In addition to one or more of the features described herein, or as an alternative, further embodiments of the processing system includes that the deep learning-based approach further includes: responsive to determining that the average distance of the corresponding key points does not exceed the threshold distance, repeating the keyframe extraction using subsequent keyframes until the video is complete.

In addition to one or more of the features described herein, or as an alternative, further embodiments of the processing system includes that performing the blur detection includes convolving the extracted keyframes with a Laplacian kernel, calculating a variance on the convolution result, and using the variance to determine whether one or more of the extracted keyframes are valid or invalid.

In addition to one or more of the features described herein, or as an alternative, further embodiments of the processing system includes that performing the blur detection includes applying a blur detect filter.

In addition to one or more of the features described herein, or as an alternative, further embodiments of the processing system includes that performing the image enhancement on the at least one of the invalid keyframes to generate the at least one enhanced keyframe includes applying a machine learning-based deblurring technique.

It will be appreciated that one or more embodiments described herein may be embodied as a system, method, or computer program product and may take the form of a hardware embodiment, a software embodiment (including firmware, resident software, micro-code, etc.), or a combination thereof. Furthermore, one or more embodiments described herein may take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the embodiment(s) may include only some of the described aspects. Accordingly, the disclosure is not to be seen as limited by the foregoing description, but is only limited by the scope of the appended claims.

What is claimed is:

1. A computer-implemented method of enhancing extracted keyframes from a video that represents an environment, comprising:
receiving the video of the environment;
extracting keyframes from the video using a machine learning model to generate extracted keyframes;
performing blur detection on the extracted keyframes to remove invalid keyframes from the extracted keyframes to generate candidate keyframes;
performing image enhancement on at least one of the invalid keyframes to generate at least one enhanced keyframe, the at least one enhanced keyframe being added to the candidate keyframes;
wherein performing the image enhancement on the at least one of the invalid keyframes to generate the at least one enhanced keyframe comprises applying a machine learning-based deblurring technique using a machine learning model trained using pairs of images, a pair of the pairs of images comprising a blurred image and a non-blurred image; and
generating a desired output based at least in part on the candidate keyframes.

2. The computer-implemented method of claim 1, wherein generating the desired output comprises at least one of:
generating a video summary of the video using the candidate keyframes;
estimating a trajectory for the video using the candidate keyframes; and
generating a point cloud of the environment using the candidate keyframes.

3. The computer-implemented method of claim 1, further comprising:
determining an array, where each item in the array indicates a keyframe of the extracted keyframes, wherein each item in the array that indicates a keyframe is assigned a value that indicates whether the keyframe is blurred;
grouping the keyframes within the array that are blurred, based on the value that indicates whether the keyframe is blurred;
setting an interval parameter to determine how many at least one consecutive blurred frame within a group of the grouped keyframes are determined as invalid and used to perform the image enhancement; and
performing the image enhancement on the at least one invalid keyframe within the group.

4. The computer-implemented method of claim 1, wherein extracting the keyframes is performed using a deep learning-based approach to extract local features and keyframes, the deep learning-based approach comprising:
for a first keyframe of the video:
add the first keyframe of the video to an image collection using a neural network model;
extracting first key points and first local features from the first keyframe of the video; and
storing the first key points as current key points and the first local features as current descriptors; and
for a second keyframe of the video:
adding the second keyframe of the video to the image collection using the neural network model;
extracting second key points and second local features from the second keyframe of the video; and
storing the second key points as next key points and the second local features as next descriptors.

5. The computer-implemented method of claim 4, wherein the deep learning-based approach further comprises:
matching the current descriptors and the next descriptors to determine corresponding key points between the current key points and next key points;
calculating an average distance of the corresponding key points; and
determining the average distance.

6. The computer-implemented method of claim 5, wherein the deep learning-based approach further comprises:
responsive to determining that the average distance of the corresponding key points exceeds a threshold distance, use the second keyframe as a current frame and repeat the deep learning-based approach to extract local features and keyframes.

7. The computer-implemented method of claim 6, wherein the deep learning-based approach further comprises:
responsive to determining that the average distance of the corresponding key points does not exceed the threshold distance, repeating the keyframe extraction using subsequent keyframes until the video is complete.

8. The computer-implemented method of claim 1, wherein performing the blur detection comprises convolving the extracted keyframes with a Laplacian kernel, calculating a variance on the convolution result, and using the variance to determine at least one of the extracted keyframes is valid.

9. The computer-implemented method of claim 1, wherein performing the blur detection comprises applying a blur detect filter by determining a global blur measure for a keyframe of the extracted keyframes by averaging a plurality of local blur measures corresponding respectively to edge locations of the keyframe, wherein each local blur measure corresponding to an edge location of the keyframe is determined by:
applying an edge detector to identify vertical edges in the keyframe of the extracted keyframes;
scanning rows of the keyframe;
defining a start position of a vertical edge in the keyframe as a first local extremum location of at least one pixel corresponding to the vertical edge in the keyframe;
defining an end position of the vertical edge in the keyframe as a second local extremum location of at least one pixel corresponding to the vertical edge in the keyframe;
determining a width of the vertical edge as a difference between the start position of the vertical edge and the end position of the vertical edge;
determining the local blur measure for the vertical edge as the width of the vertical edge.

10. The computer-implemented method of claim 1, wherein extracting the keyframes from the video using the machine learning model to generate the extracted keyframes comprises:
extracting, using a machine learning model, a first key feature point set corresponding to a first video frame of the video;
extracting, using the machine learning model, a second key feature point set corresponding to a second video frame of the video;
computing a mean pixel distance between the first key feature point set corresponding to the first video frame of the video and the second key feature point set corresponding to the second video frame of the video;
determining whether the mean pixel distance between the first key feature point set corresponding to the first video frame of the video and the second key feature point set corresponding to the second video frame of the video is greater than a threshold; and
determining that the second video frame of the video is one extracted keyframe of the extracted keyframes, in response to the mean pixel distance between the first key feature point set corresponding to the first video frame of the video and the second key feature point set corresponding to the second video frame of the video being greater than the threshold.

11. A processing system comprising:
a memory comprising computer readable instructions; and
a processing device for executing the computer readable instructions, the computer readable instructions controlling the processing device to perform operations comprising:
receiving a video of an environment;
extracting keyframes from the video using a machine learning model to generate extracted keyframes;
performing blur detection on the extracted keyframes to remove invalid keyframes from the extracted keyframes to generate candidate keyframes;
performing image enhancement on at least one of the invalid keyframes to generate at least one enhanced keyframe, the at least one enhanced keyframe being added to the candidate keyframes;
wherein performing the image enhancement on the at least one of the invalid keyframes to generate the at least one enhanced keyframe comprises applying a machine learning-based deblurring technique using a machine learning model trained using pairs of images, a pair of the pairs of images comprising a blurred image and a non-blurred image; and
generating a desired output based at least in part on the candidate keyframes.

12. The processing system of claim 11, wherein generating the desired output comprises at least one of:
generating a video summary of the video using the candidate keyframes;
estimating a trajectory for the video using the candidate keyframes; and
generating a point cloud of the environment using the candidate keyframes.

13. The processing system of claim 11, wherein extracting the keyframes is performed using a deep learning-based approach to extract local features and keyframes.

14. The processing system of claim 13, wherein the deep learning-based approach comprises:
for a first keyframe of the video,
adding the first keyframe of the video to an image collection using a neural network model;
extracting first key points and first local features from the first keyframe of the video; and
storing the first key points as current key points and the first local features as current descriptors; and
for a second keyframe of the video,
adding the second keyframe of the video to the image collection using the neural network model;
extracting second key points and second local features from the second keyframe of the video; and
storing the second key points as next key points and the second local features as next descriptors.

15. The processing system of claim 14, wherein the deep learning-based approach further comprises:
matching the current descriptors and the next descriptors to determine corresponding key points between the current key points and next key points;
calculating an average distance of the corresponding key points; and
determining the average distance.

16. The processing system of claim 15, wherein the deep learning-based approach further comprises:
responsive to determining that the average distance of the corresponding key points exceeds a threshold distance, use the second keyframe as a current frame and repeat the deep learning-based approach to extract local features and keyframes.

17. The processing system of claim 15, wherein the deep learning-based approach further comprises:
responsive to determining that the average distance of the corresponding key points does not exceed the threshold distance, repeating the keyframe extraction using subsequent keyframes until the video is complete.

18. The processing system of claim 11, wherein performing the blur detection comprises convolving the extracted keyframes with a Laplacian kernel, calculating a variance on the convolution result, and using the variance to determine at least one of the extracted keyframes is invalid.

19. The processing system of claim 11, wherein performing the blur detection comprises applying a blur detect filter.

20. The processing system of claim 11, wherein extracting the keyframes from the video using the machine learning model to generate the extracted keyframes comprises
extracting, using the machine learning model, a first key feature point set corresponding to a first video frame of the video;
extracting, using the machine learning model, a second key feature point set corresponding to a second video frame of the video;
computing a mean pixel distance between the first key feature point set corresponding to the first video frame of the video and the second key feature point set corresponding to the second video frame of the video;
determining whether the mean pixel distance between the first key feature point set corresponding to the first video frame of the video and the second key feature point set corresponding to the second video frame of the video is greater than a threshold; and
determining that the second video frame of the video is one extracted keyframe of the extracted keyframes, in response to the mean pixel distance between the first key feature point set corresponding to the first video frame of the video and the second key feature point set corresponding to the second video frame of the video being greater than the threshold.
